(19) United States
(12) Patent Application Publication
(10) Pub. No.: US 2003/0232171 A1
(43) Pub. Date: Dec. 18, 2003

(54) Carpet tile constructions and methods

(76) Inventors: J. Todd Keith, LaGrange, GA (US); Kenneth B. Higgins, LaGrange, GA (US)

Correspondence Address: Milliken & Company, P.O. Box 1927, Spartanburg, SC, 29304, US

(21) Appl. No.: 10/193,822

(22) Filed: Jul. 12, 2002

Related U.S. Application Data
(60) Provisional application No. 60/388,893, filed on Jun. 14, 2002.

(51) Int. Cl. B32B 33/00; B32B 3/02

(52) U.S. Cl. 428/95

(57) ABSTRACT

An improved flooring, floor covering, carpet, carpet tile, and method is provided. A hardback like carpet includes a primary carpet having a base and a plurality of pile-forming yarns projecting outwardly from one side. A layer of reinforcement material is bonded to the base on the side opposite the pile forming yarns. The reinforcement layer is adjacent to and may be embedded in, a layer of a polymer such as a polyurethane or hot melt. A non-woven backing is attached to the reinforcement layer by the polymer. An apparatus and process for forming the low weight cushioned carpet or carpet tile of the present invention are also provided.

### CROSS-REFERENCE TO RELATED APPLICATIONS

This application claims priority to and the benefit of U.S. Provisional Patent Application Serial No. 60/388,893, filed on Jun. 14, 2002, hereby incorporated by reference herein.

### FIELD OF THE INVENTION

The present invention relates to surface covering, wall covering, floor covering, flooring material, carpet, roll product, carpet tile, or the like, and more particularly, to carpet or carpet tile constructions and related methods. A process and apparatus for forming the floor covering, carpet or carpet tile of the present invention are also provided.

### BACKGROUND OF THE INVENTION

As described in U.S. Pat. Nos. 4,522,857, 5,540,968, 5,545,276, 5,948,500, and 6,203,881 (all hereby incorporated by reference herein) carpet and carpet tiles having cushioned backings are well known to those of skill in the art. As described in the U.S. Pat. No. 5,948,500 or 6,203,881 patent and as shown herein, an example of a tufted carpet product is illustrated in FIG. 1A and an example of a bonded carpet product is illustrated in FIG. 1B.

In the tufted carpet of FIG. 1A, a primary carpet fabric 12 is embedded in an adhesive layer 16 in which is embedded a layer of glass scrim or non-woven material 18. A foam base composite 19 is likewise adhesively bonded to the adhesive layer 16. In the tufted carpet illustrated in FIG. 1A, the primary carpet fabric 12 includes a loop pile layer 20 tufted through a primary backing 22 by a conventional tufting process and held in place by a pre-coat backing layer of latex 24 or other appropriate adhesives including a hot melt adhesive or the like. The foam base composite 19 of the tufted carpet product includes an intermediate layer 26 molded to a layer of urethane foam 28 as illustrated.

The bonded carpet product (FIG. 1B) employs the same type of foam base composite 19 adhesively bonded by adhesive laminate layers 16. However, the primary bonded carpet fabric 12 has somewhat different components from that of the tufted product in that it has cut pile yarns 34 implanted in a PVC, latex, or hot melt adhesive 36 having a woven or non-woven reinforcement or substrate layer 38 of fiberglass, nylon, polypropylene, or polyester.

The practice utilized in forming the product disclosed in the U.S. Pat. No. 4,522,857 and other known products involves preforming and curing the foam base composite 19 of urethane foam and backing material by practices such as are disclosed in U.S. Pat. Nos. 4,171,395, 4,132,817 and 4,512,831, to Tillotson (all hereby incorporated by reference herein). As described in these patents, only after this foam base composite is formed and cured to some degree as a modular component, is it laminated to the carpet base. For example, a first company may produce the foam base composite 19, roll it, and ship it to a second company who takes the roll of foam base composite 19, unrolls it, and laminates it to a primary carpet fabric 12 and a scrim 18 using hot melt adhesive 16.

As described in the above-mentioned U.S. Pat. No. 5,948,500, the cost associated with such modular formation and assembly practices may be reduced by a simplified, continuous, in-line or in-situ operation, for example, in which a primary carpet fabric, either with or without a stabilizing layer of scrim or the like, is laid directly into a polyurethane-forming composition and thereafter curing the polyurethane. The process can be made even more efficient if the polyurethane-forming composition requires no pre-curing prior to joining the carpet base.

Prior to the invention described in the U.S. Pat. No. 5,948,500, the known processes directed to the application of the polyurethane cushioned backings to fabric substrates relied on the extremely close control of temperature in both the polyurethane composition and the adjoined fabric layer to effect stability through pre-cure of the polyurethane prior to lamination of the primary carpet to form a composite structure. Such pre-cure had been largely considered necessary in order to yield a stable foam structure to which the primary carpet backing could be applied. The application of heat to the polyurethane composition prior to joiner of the heated fabric backing caused polymer cross linking which had been thought to be necessary to stabilize the foam mixture to a sufficient degree to prevent the collapse of the foam.

The invention described in the U.S. Pat. No. 5,948,500 also provides a particularly simple composite structure, such as primary carpet fabric, hot melt adhesive, glass mat, polyurethane foam, and felt, amendable to continuous, in-line or in-situ formation of a stable cushion carpet composite which is not believed to have been previously utilized. Specifically, it had not been previously recognized that a continuous process could be used to bring all the layers of the cushioned carpet composite together by laying a glass layer or primary carpet fabric, either with or without some degree of preheat, directly into a mechanically frothed polyurethane-forming composition prior to curing the polyurethane.

As indicated, the prior art carpet forming processes typically required the separate formation of a foam base composite having a backing layer and a layer of urethane foam. The backing layer is then used as an intermediate layer to which a primary carpet fabric and reinforcing layer can be adhesively bonded. As described in at least one example in the U.S. Pat. No. 5,948,500, the polyurethane is deposited on a felt backing layer which remains as the backing and a separate glass layer is added over the top of the polyurethane. As described in at least one example in the U.S. Pat. No. 5,948,500, the base of the primary carpet fabric is adhesively bonded to a layer of non-woven glass reinforcement material to form a preliminary composite. A puddle of polyurethane-forming composition is simultaneously deposited across a woven or non-woven backing material. The preliminary composite and the polyurethane-forming composition are thereafter almost immediately brought together with the preliminary composite being laid into, and supported by, the polyurethane-forming puddle. The entire structure is then heated to cure the polyurethane forming composition. The preliminary composite may be slightly heated to about 120 degrees F. to improve heating efficiency although the process may likewise be carried out without such preheating.

A superior cushion backed carpet tile or modular cushion back carpet tile product on the market today, for example, sold under the trademark Comfort Plus® by Milliken & Company of LaGrange, Georgia has, for example, a primary carpet fabric with a yarn face weight of about 20 to 40 oz/yd², a hot melt layer of about 38 to 54 oz/yd², a cushion of about 0.10 to 0.2 inches thick, a weight of about 28-34 oz/yd², and a density of about 18 lbs. per cubic foot, and an overall product height of about 0.4%-0.8 inches. This superior cushion back carpet tile provides excellent resilience and under foot comfort, exhibits performance characteristics that rate it for very heavy commercial use, and has achieved a notable status throughout the industry as having excellent look, feel, wear, comfort, and cushion characteristics, performance, properties, and the like. Such a superior cushion backed carpet tile is relatively expensive to produce due to the high quality and quantity of materials utilized (see FIG. 9).

Although attempts have been made at reducing the cost of floor coverings or carpet by using lower quality materials, such attempts have not been particularly successful. Low quality products tend to have a less than desirable look, feel, wear, comfort, cushion, and the like. Hence, most such products have not been accepted in the industry and have failed commercially.

One successful relatively lower cost floor covering, carpet, or carpet tile and process for producing such a product is described in U.S. patent application Ser. No. 09/587,654 and in published U.S. patent application 20020034606 A1, published Mar. 21, 2002, each of which is hereby incorporated by references herein. The Ser. No. 09/587,654 application and 20020034606 publication each describe a process for producing a low weight composite structure amenable to continuous, in-line or in-situ formation as a stable cushion carpet composite. One embodiment of such a low weight cushion carpet composite incorporates a low face weight primary carpet fabric of either tufted or bonded construction which is adhesively bonded to a layer of reinforcement material to form a preliminary composite. This preliminary composite is thereafter laid into a puddle of polyurethane-forming material. The resulting structure is then heated to cure the polyurethane-forming material thereby yielding a cushioned structure.

Hardback carpet tiles such as shown for example in FIG. 10 typically have a similar carpet face as cushion back carpet tile but have a hardback backing of one or more layers of a relatively thick and rigid hardback hot melt coating or material. Hardback tiles are described for example in U.S. Pat. Nos. 3,964,353, 3,968.709 and 4,647,484 hereby incorporated by reference herein.

One superior hardback carpet tile embodiment marketed by Milliken & Company under the trademark EVERWHER™ is described in the following table (see FIG. 10).

EVERWHER ™ Hardback Carpet Tile Specification

| | Obex |
|---|---|
| 1. | Product Name: First Appearances (Obex) |
| 2. | Face: Cut Pile |
| 3. | Primary Backing: Woven Colback (4 oz/sq yd) |
| 4. | Total Finished Yarn Weight: 26 oz/sq yd |
| 5. | Stitches Per Inch: 5.59 |
| 6. | Tufting Gauge: 5/32 |
| 7. | Yarn Polymer: Nylon |
| 8. | Yarn Type: Nylon |
| 9. | Yarn Twist: 4 by 4; S by “Z” |
| 10. | Yarn Ply:2 |
| 11. | Heatset: Yes |
| 12. | Yam Size: 1.57/2 |
| 13. | Dyeing Method: Jet Dye, Millitron jet dye machine |
| 14. | Precoat adhesive: Styrene Butadiene Latex, 12 oz/sq yd coating |
| | weight |
| 15. | Lamination Tiecoat Adhesive: Hot melt with a bitumen and |
| | polypropylene resin base at 46 oz/sq yd |
| 16. | Stabilizing Reinforcement: Fiberglass mat, 2 oz/sq yd, modified |
| | acrylic binder |
| 17. | Lower Tiecoat Weight: Hot melt (Everwher) with polypropylene |
| | resin base at 60 oz/sq yd |
| 18. | Everwher density: 18l b/gallon at a thickness of 0.100 inch. |
| 19. | Modular shape and size: 18″ by 18″ or 36″ by 36″ square tile |
| 20. | Cutting method: Die cut face up. |

Typically, hardback carpet tiles and cushion back carpet tiles are vastly different products (cushion back carpet tiles have a soft, cushion or foam backing, hardback carpet tiles have a substantially rigid, hard, non-foam backing) and are usually produced on different or separate ranges, machines, equipment, etc.

### OBJECTS AND SUMMARY OF THE PRESENT INVENTION

In view of the foregoing, it is a general object of the present invention to provide a novel surface covering, wall covering, floor covering, flooring material, carpet, roll product, or carpet tile.

It is a further object of the present invention to provide a novel hardback tile carpet or carpet tile.

It is at least one object of the present invention to provide a hardback or hardback like carpet tile having a non-woven release layer laminated to a carpet face with a thin adhesive layer. For example, the thin adhesive layer may be a polyurethane foam composition, a hot melt adhesive, or the like.

It is a further object of the present invention to provide a modular hardback like carpet tile.

It is still another object of the present invention to provide a low weight modular hardback like carpet tile exhibiting performance characteristics that rate it for heavy commercial use.

It is a further object of the present invention to provide a method of forming a hardback like surface covering, wall covering, flooring, carpet, carpet composite, carpet tile, or the like.

It is an object of the present invention to provide a carpet composite or tile wherein a reinforcement layer is disposed, at least partially, within a polymer mass which is adjacent to a primary carpet with such primary carpet being laid in-situ into a puddle of polymer atop a woven backing.

It is a related object of the present invention to provide a carpet composite or tile wherein a primary carpet fabric is joined to a reinforcement layer and laid in-situ into a polyurethane-forming composition which has not undergone a pre-cure operation.

It is a further object of the present invention to provide a process for the formation of a carpet composite or tile wherein a reinforcement layer is adhered to the base of a primary carpet fabric, a polyurethane-forming composition is applied to a non-woven backing layer, and the primary carpet fabric with the adhered reinforcement layer is attached to the polyurethane-forming composition to form the carpet composite.

It is still a further related object of the present invention to provide a continuous process for the in-situ formation of a carpet composite wherein a reinforcement layer is adhered between a primary carpet base and a backing layer through the in-situ application of a polyurethane forming composition.

It is still a further related object of the present invention to provide an apparatus for carrying out the continuous in-situ formation of a carpet composite.

It is yet another object that the carpet composite and carpet tile of the present invention may be printed with orientation independent designs or designs having the ability to seam properly without cutting the tiles in register with the design and to allow the carpet to be installed monolithically as well as by conventional quarter turn “Parquet”, or by ashler (brick). The preferred installation techniques are monolithic or ashler with or without floor adhesives.

In accordance with a particular example of the present invention, a modular carpet composite is cut into modular carpet tiles or carpet squares, for example, 18 inches×18 inches, 36 inches×36 inches, 50 cm×50 cm, 1 meter×1 meter, 48 inchcs×48 inches, or the like.

Also, the carpet composite or carpet tile of the present invention may be installed on site or on flooring by all of the conventional installation techniques as well as can be constructed for adhesive-free installation, self-stick, or the like.

Also, the carpet composite and carpet tile of the present invention may be printed with orientation independent designs or designs having the ability to seam properly without cutting the tiles in register with the design and to allow the carpet to be installed monolithically as well as by conventional quarter turn “Parquet”, or by ashler (brick). The preferred installation techniques are monolithic or ashler with or without floor adhesives.

In accordance with the present invention, it has been unexpectedly discovered that a carpet composite or carpet tile having excellent look, wear, and exhibiting performance characteristics that rate it for heavy commercial use can be formed by using a thin polyurethane layer as an adhesive layer.

In accordance with the present invention, a modular carpet tile is provided having an overall height of about 0.20 to 0.5 inches thick depending on the construction of the carpet tile (the number of layers or components) and which can be cut in any conventional shape or size.

It is yet a further feature of the present invention to provide an apparatus for use in the continuous in-situ formation of a carpet composite wherein the apparatus includes a polymer application unit for depositing a polyurethane-forming composition, hot melt adhesive, or other suitable polymer in combination with an adhesive application apparatus for adhering a reinforcement layer to the base of a primary carpet fabric. The polymer application unit and the adhesive application unit being simultaneously operable in controlled relation to one another such that the primary carpet with the adhered reinforcement layer may be laid directly into the polymer.

In accordance with one aspect of the present invention, a carpet, composite, or tile is provided. The carpet includes a primary carpet having a primary base and a plurality of pile-forming yarns projecting outwardly from one side. A layer of reinforcement material is bonded to the primary base on the side away from the pile-forming yarns. The reinforcement material is adjacent to, and embedded at least partially in, a layer of polymer such as polyurethane. A backing material is preferably disposed on the underside of the polymer layer. The backing material may include an adhesive backing on the side away from the polymer layer.

In accordance with another aspect of the present invention, a process for making selectively a cushioned carpet, a low weight cushioned carpet, and a hardback like carpet is provided. The process involves obtaining a primary carpet fabric comprising a plurality of pile-forming yarns extending outwardly from one side of a primary base. A layer of reinforcement material is adhered to the primary carpet fabric on the side, from which the pile-forming yarns do not extend, thereby forming a preliminary composite. A puddle of polymer such as a polyurethane-forming composition is applied to one side of a backing material and preferably doctored to desired thickness to form a thick cushion layer, a thin cushion layer, or an even thinner adhesive layer. The preliminary composite is then adhered to the cushion or adhesive layer. Following this mating operation, the carpet is cut to size or into tiles.

In accordance with one object of the invention, an embodiment having a frothed polyurethane adhesive layer and a felt backing (FIG. 11) provides a carpet tile product which may have a similar height as other hardback products but which provides some amount of cushion or comfort to the user due to the thin polyurethane cushion and the felt backing material.

### BRIEF DESCRIPTION OF THE DRAWINGS

FIG. 1A is a cut-away view of a tufted carpet with a cushioned composite structure.

FIG. 1B is a cut-away side view of a bonded carpet incorporating a cushioned composite structure.

FIG. 2 is a schematic view illustrating an exemplary embodiment of the apparatus and process of the present invention.

FIG. 3A is a cut-away side view of a tufted carpet incorporating a structure formed by the apparatus and process of the present invention as illustrated in FIG. 2.

FIG. 3B is a cut-away side view of a bonded carpet incorporating a structure formed by the apparatus and process of the present invention as illustrated in FIG. 2.

FIG. 4A is a cut-away side view of an alternative embodiment of a tufted carpet having no reinforcement layer.

FIG. 4B is a cut-away side view of an alternative embodiment of a bonded carpet having no reinforcement layer.

FIG. 5 is a schematic view illustrating an alternative apparatus and process according to the present invention for forming a cushioned carpet composite without separate adhesive bonding between the primary carpet and the reinforcement layer.

FIG. 6A is a cut-away side view of an alternative structure for a tufted carpet formed by the apparatus and process illustrated in FIG. 5.

FIG. 6B is a cut-away side view of an alternative structure for a bonded carpet formed by the apparatus and process illustrated in FIG. 5.

FIG. 7 is a schematic view illustrating yet another alternative apparatus and process according to the present invention for forming a cushioned carpet composite without separate adhesive bonding between the primary carpet and the reinforcement layer as illustrated in FIGS. 6A and 6B.

FIG. 8 is a schematic flow diagram of the production of low weight modular carpet tiles in accordance with one embodiment of the present invention. FIGS. 9-11 are cut-away side views of respective tufted carpet, composite, or tiles.

FIG. 9 is a cut-away side view of a cushion back carpet or tile like that of FIG. 3A.

FIG. 10 is a cut-away side view of a hardback carpet or tile.

FIG. 11 is a cut-away side view of a novel hardback like carpet or tile in accordance with at least one embodiment of the present invention.

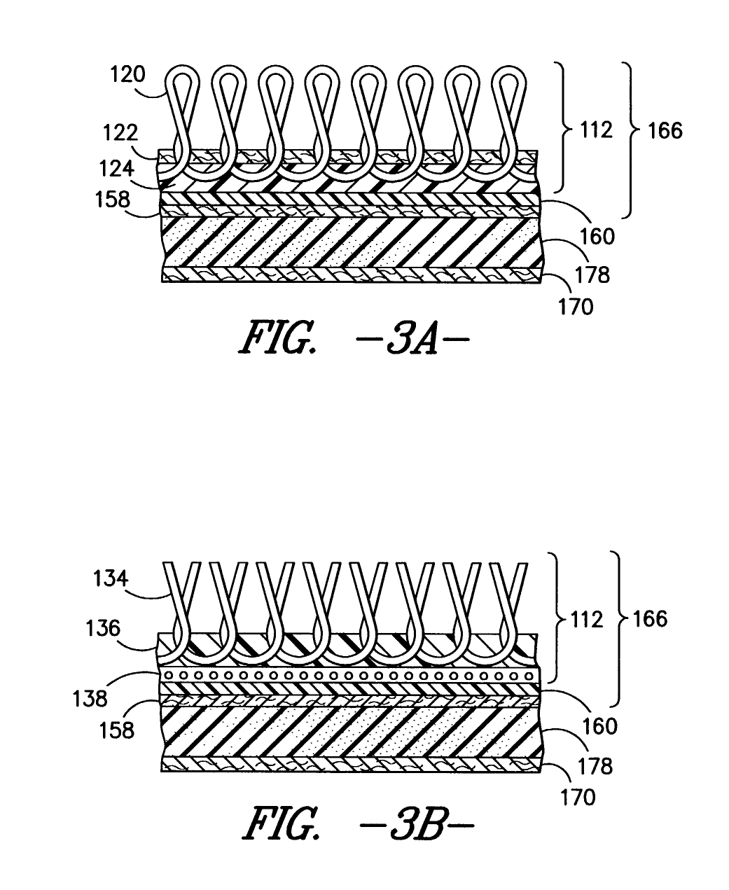

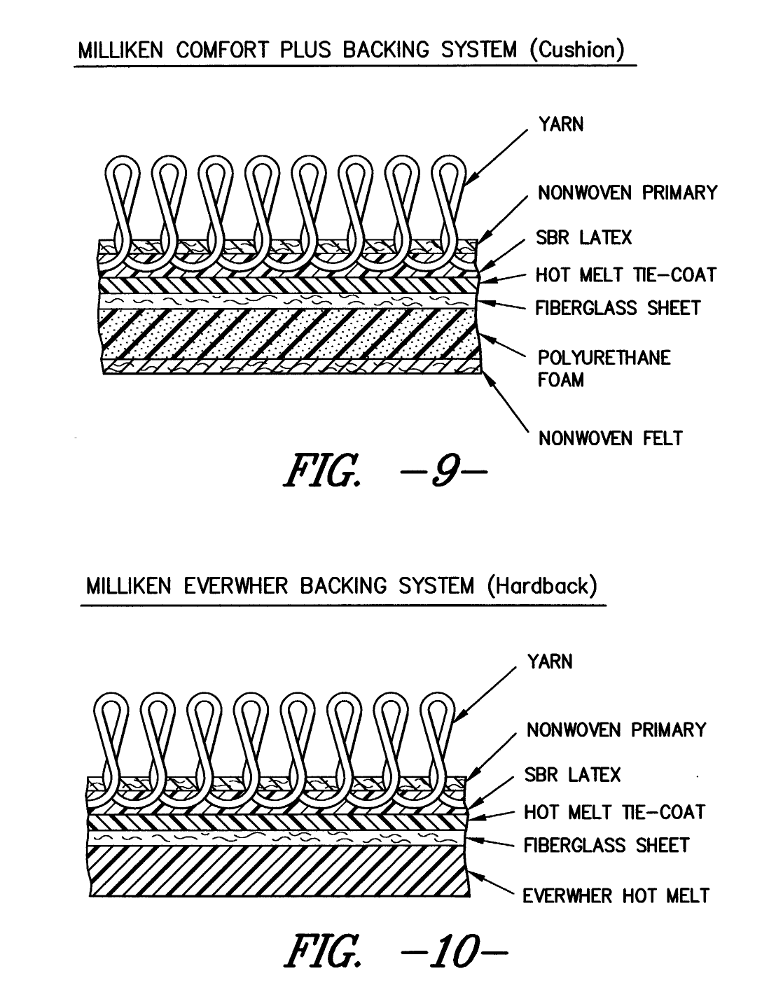

Although FIGS. 9-11 show a loop pile tufted primary carpet and FIG. 3B shows a bonded cut pile primary carpet, it is to be understood that a bonded or tufted loop and/or cut pile may be used and that the pile may be sculptured, printed, dyed, and or the like as desired.

While the invention will be described and disclosed in connection with certain preferred embodiments and procedures, it is by no means intended to limit the invention to such specific embodiments and procedures. Rather it is intended to cover all such alternative embodiments, procedures, and modifications thereto as may fall within the true spirit and scope of the invention as defined and limited only by the appended claims.

### DETAILED DESCRIPTION

In accordance with the present invention, a surface covering, wall covering, flooring, carpet, floor covering, carpet composite, or modular carpet tile and method is provided which is aesthetically pleasing, exhibits performance characteristics that rate it for heavy commercial use, and which may be dyed, printed, and installed as can be done with conventional carpet, composite, or tiles.

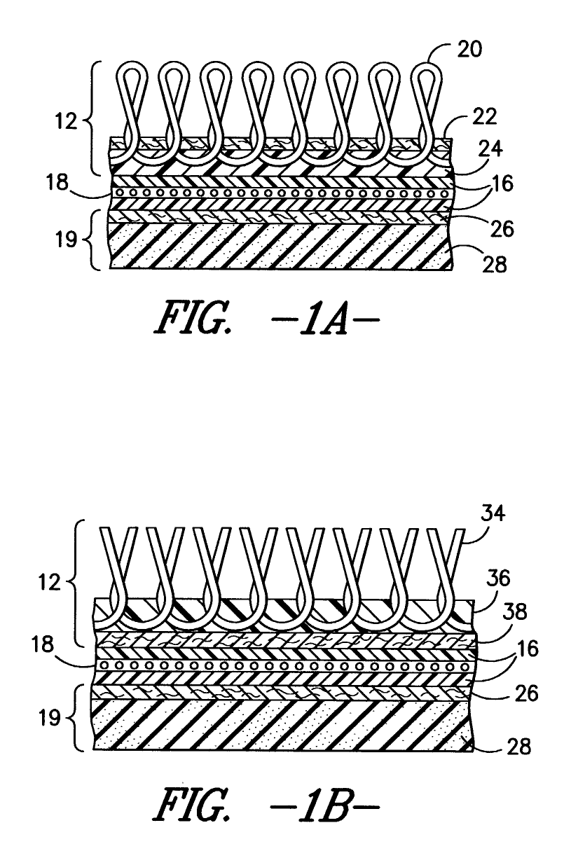

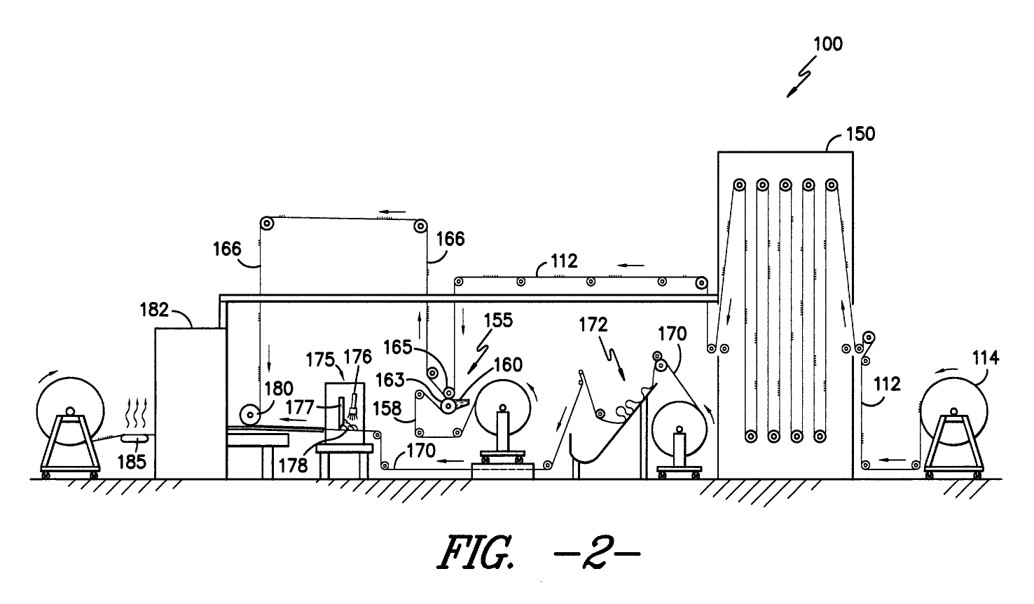

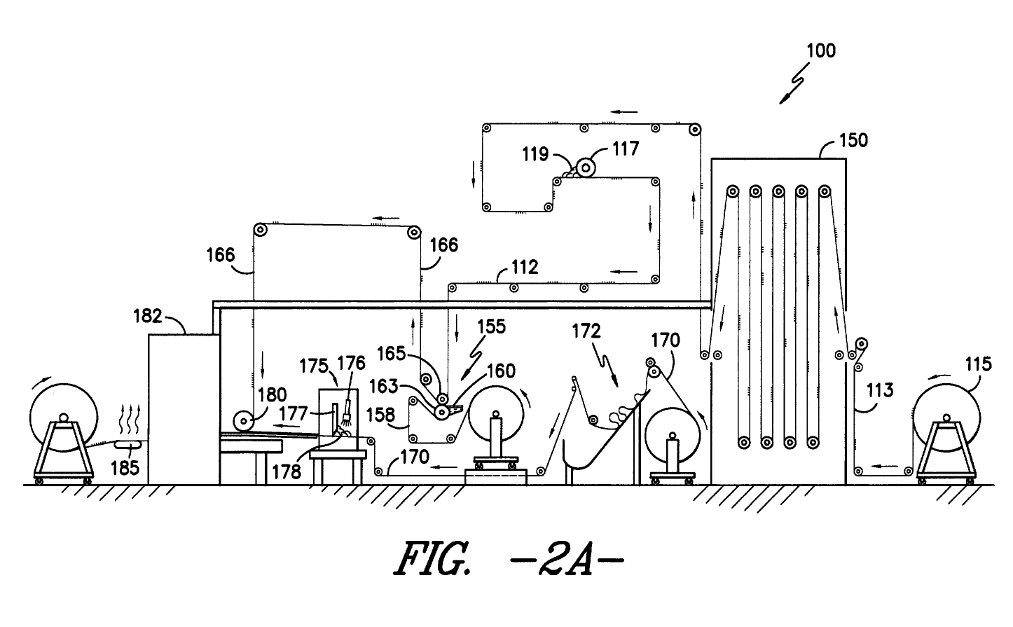

A schematic view illustrating an exemplary apparatus and process used in selectively forming the cushion back product of FIGS. 3A, 3B, and 9, the low weight product of published U.S. application 200200346006, and the surface covering, wall covering, flooring, floor covering, carpet or tile of the present invention (FIG. 11) is illustrated in FIG. 2. The apparatus is designated generally by reference numeral 100. As illustrated, a primary carpet fabric 112 which may incorporate either a tufted or a bonded configuration (with loop and/or cut pile) as described above is drawn from a mounted carpet roll 114. As indicated previously, the primary carpet fabric 112 preferably includes a plurality of pile-forming yarns projecting outwardly from one side of a primary backing or base. If the primary carpet 112 used in the present invention is a tufted carpet, its configuration will preferably conform to that of the primary carpet 12 illustrated in regard to that in FIG. 1A, while if the primary carpet 112 used in the present invention is a bonded product, its configuration will be that of the primary carpet 12 illustrated in FIG. 1B. It is contemplated that the primary carpet 112 may include one or more backing or base layers.

It is to be understood that, as with the prior art products, wherein the primary tufted or bonded carpet fabric 12 may have different embodiments, the component structure of the primary carpet fabric is not critical to the present invention. Rather it is intended that any primary carpet fabric having a pile forming portion and a primary base may be utilized as the primary carpet fabric. By “primary base” is meant any single layer or composite structure including, inter alia, the commonly used layered composite of primary backing 22 and latex pre-coat 24 previously described in relation to the tufted product (FIG. 1A) and the adhesive layer 36 with reinforcement substrate 38 previously described in relation to the bonded product (FIG. 1B). As will be appreciated, the use of polyester in the primary base structure may be desirable due to the eventual heat curing such structure may undergo. Other embodiments as may occur to those of skill in the art may, of course, also be utilized. For example, in the bonded product, the pile forming yarns could be heat tacked to the substrate 38 as described in U.S. Pat. No. 5,443,881 (hereby incorporated by reference herein) to permit simplified construction of a primary carpet.

Alternative embodiments including those disclosed in U.S. Pat. No. 4,576,665 to Machell (incorporated by reference) may likewise be utilized. For example, it is contemplated that specialized primary backings such as non-woven structures comprising fiberglass sandwiched between layers of polyester may be utilized in the primary tufted carpet to impart the desired properties relating to stability thereby potentially reducing or even eliminating the need for the secondary backing or the latex pre-coat presently utilized. Moreover, it is contemplated that if a pre-coat is to be utilized, it may be added directly in-line in an operation prior to any adhesive operation.

With regard to the cushion back carpet or tile of FIG. 3A, the primary carpet fabric 112 preferably comprises a loop pile layer 120 of pile-forming yarns tufted into a primary backing 122 as is well known and held in place by a pre-coat of adhesive 124 such as latex or a hot melt adhesive. It is contemplated that the latex or hot melt adhesive may be added in-line after removal from the carpet roll prior to the application of any other adhesive as described below. The carpet may be steamed after addition of the pre-coat to facilitate subsequent printing operations if desired to reduce stresses. The two basic primary backing constructions are woven polypropylene and non-woven polyester. Each material may have a variety of construction characteristics engineered for a specific end use. The preferred primary backing material is 20 pick per inch, woven polypropylene, with needle punched nylon fleece.

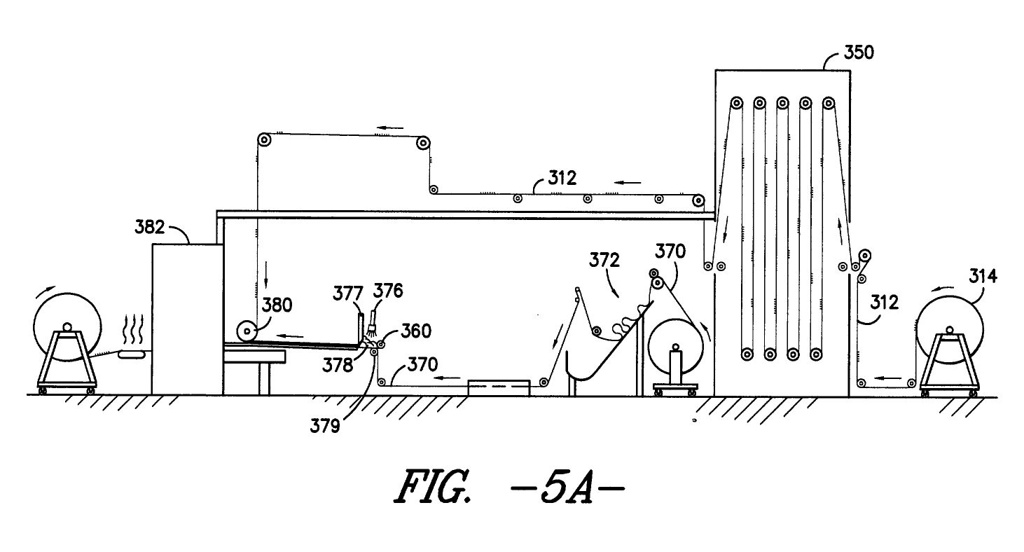

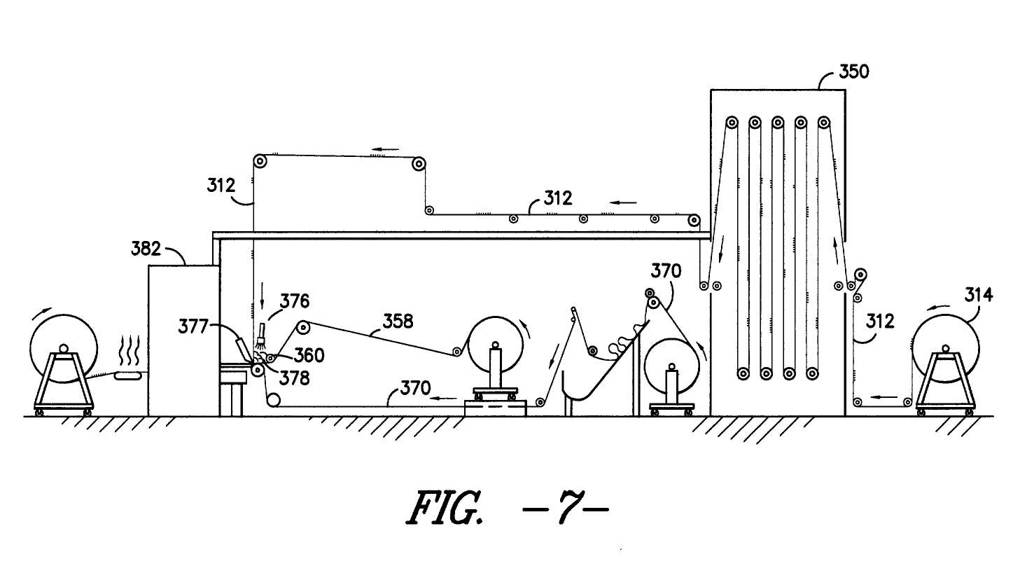

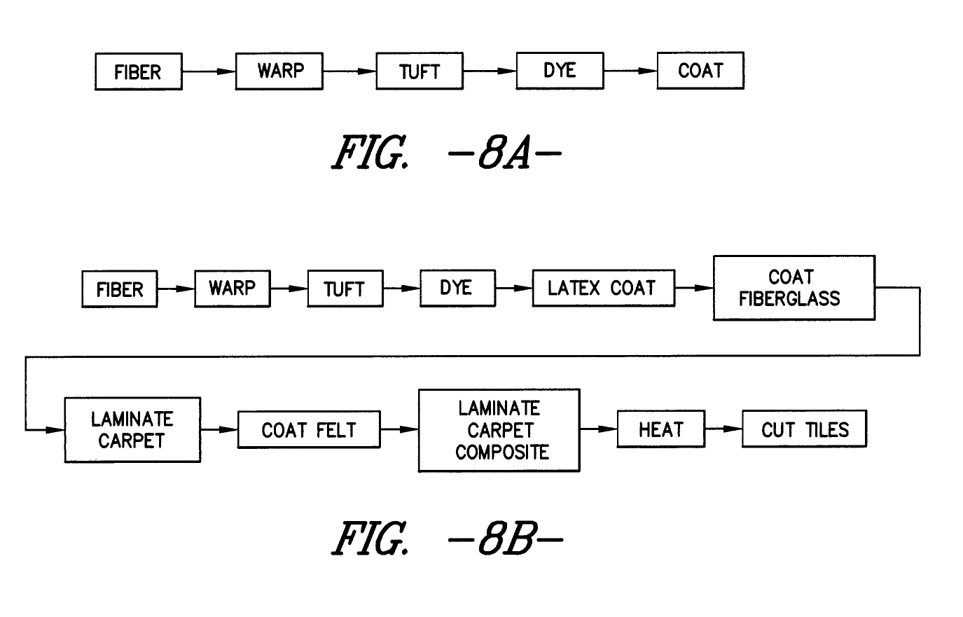

Next, this primary carpet is split in half and rolled to form, two separate six foot wide rolls of split primary carpet precursor. Next, one roll of the split primary carpet precursor is used as carpet 114 in the apparatus of FIG. 2 or carpet 314 in FIG. 5 or 7. The latex pre-coat or hot melt adhesive coat 124 is added to the back of the primary carpet precursor to form a primary carpet fabric 112 in the upper run of the apparatus of FIG. 2 downstream of the accumulator 150 and upstream of the reinforcement bonding unit 155. For example, a thin layer of latex pre-coat is applied to the back of the primary carpet precursor using a coating roller. In accordance with one embodiment, the primary carpet precursor (not having a latex pre-coat) is rolled or wound with the primary backing 122 exposed.

Also, it is contemplated that the apparatus and process may include the entire assembly process from tufting the yarn in the primary backing, dying the tufted yarn, latex pre-coating the back of the primary backing, hot-melt coating the fiberglass reinforcing material, foam coating the felt secondary backing, laminating the primary carpet, reinforcing fiberglass, and foam cushioning layer, heating or curing the laminate, and cutting the carpet composite into carpet tiles, runners, area rugs, or the like. Also, it is contemplated that the process may be broken down into its respective steps and done in a batch rather than a continuous mode, although the continuous mode of operation is preferred. For example, the primary carpet may be formed in one operation and placed on rolls. The cushion backing or foam layer may be formed in a separate operation and be placed on a roll. The two may be joined by a mating unit using an adhesive, hot melt, hot melt with reinforcing layer, or the like.

In the bonded cushion back carpet of FIG. 3B, the primary carpet fabric 112 preferably comprises a plurality of cut pile yarns 134 implanted in an adhesive 136 such as a latex or hot melt adhesive which is laminated to a reinforcement or substrate layer 138 of a woven or non-woven material including fiberglass, nylon, polyester, or polypropylene. It is contemplated that this substrate layer 138 may be pre-coated with latex or other thermoplastic polymers to permit melting adhesion with the cut pile yarns 134 upon the application of heat, thereby potentially reducing or eliminating the need for the latex or hot melt adhesive 136.

The yarns 120, 134 may be either spun or filament yarns and are preferably formed from a polyamide polymer such as nylon 6 staple, nylon 6 filament, or nylon 6,6 staple, nylon 6,6 filament, available from DuPont Fibers in Wilmington, Del., although other suitable natural or synthetic yarns may likewise be employed as will be recognized by those of skill in the art. By way of example only and not limitation, other materials, which might be used, include polyester staple or filament such as polyethylene terephthalate (PET), and polybutylene terephthalate (PBT); polyolefins, such as polyethylene and polypropylene staple or filament; rayon; and polyvinyl polymers such as polyacrylonitrile, wool, nylon/wood blends, Lyocell, rayon, saran, acetate, glass, aramid, fluorocarbon, Sulfar, acrylic, Pelco, olefin, melamine, polybenzimidazole, and combinations thereof. A variety of deniers, plies, twist levels, air entanglement, and heatset characteristics can be used to construct the yarn.

In the tufted product, the adhesive pre-coat 124 is preferably styrene butadiene rubber (SBR) latex but other suitable materials such as polyvinyl chloride (PVC), ethylene vinyl acetate (EVA), polyurethane, acrylic, and hot melt adhesives as are well known to those of skill in the art may likewise be utilized. In the event that a hot melt adhesive is utilized, it is contemplated that a reinforcement material such as a glass scrim could be directly attached to form a composite laminate without the use of adhesives. Moreover, as previously indicated, it is contemplated that the adhesive pre-coat 124 may be entirely eliminated in the tufted product if the loop pile 120 is tufted in suitably stable relation to the primary backing 122. The commonly used hot melts are bitumen, polyolefin-based thermoplastic, and polyurethane. The preferred hot melt material is polyolefin based thermoplastic.

Referring again to FIG. 2, the primary carpet fabric 112 is conveyed by means of a plurality of rolls through an accumulator 150 as is well known in the art to a reinforcement bonding unit 155. Simultaneously with the conveyance of the primary carpet fabric 112 to the reinforcement bonding unit 155, a sheet of reinforcement material 158 is likewise conveyed to the reinforcement bonding unit 155. The reinforcement material 158 is preferably fiberglass non-woven material such as a 2.0 oz/yd² fiberglass mat or tissue containing a urea formaldehyde or acrylic binder although alternative materials may include woven glass, woven polyester, and non-woven polyester.

At the reinforcement bonding unit 155, an adhesive 160 (FIGS. 3A, 3B) such as a hot melt adhesive is preferably applied to the reinforcement material 158 by means of a film coater or other such unit as are well known. The reinforcement material 158 and the primary carpet fabric 112 are thereafter preferably passed in mating relation between joining members such as rolls 163, 165, thereby bonding the reinforcement material 158 to the underside of the primary carpet fabric 112. That is, the reinforcement material 158 is bonded on the side of the primary carpet fabric 112 from which the pile forming yarns do not project. The bonding of the reinforcement material 158 to the underside of the primary carpet fabric 112 produces a preliminary composite 166 which is thereafter laid into a puddle of polymer or foam forming composition such as a polyurethane-forming composition as described below.

Although the reinforcement bonding unit 155 is illustrated in its preferred embodiment as incorporating a film coater, it is to be understood that alternative equivalent means such as application rolls, spray headers and the like may also be utilized. By way of example only, and not limitation alternative means for the application of adhesive 160 are disclosed in U.S. Pat. No. 4,576,665 to Machell. While the preliminary composite 166 is being formed, a backing material 170 such as a non-woven backing is passed through a scray 172 to a polymer application unit 175 which preferably includes a polymer discharge unit 176 and a doctor blade 177. The backing material 170 is coated with a polymer 178 such as a polyurethane-forming composition as disclosed more fully below.

In the preferred embodiment, the backing material 170 is woven or non-woven synthetic fiber material such as 10% to 100% polyester/0% to 90% polypropylene, preferably 50% polyester, 50% polypropylene non-woven fibrous material which is available from Spartan Mills Company in Spartanburg, S.C. While this represents the backing material of preference, it is to be understood that any number of alternative compositions may likewise be utilized as dictated by requirements regarding shrinkage and installation. The commonly used secondary backing materials include non-woven polyester, non-woven polyester and polypropylene blends, or woven polypropylene. By way of example only, in instances where very little or no shrinkage may be tolerated, the backing material may be up to 100% polyester. Further, while a non-woven backing material may be preferred, it is contemplated that either woven or non-woven constructions may be utilized as can materials other than polyester, polypropylene, and polyester/polypropylene such as nylon, fiberglass and the like. The thickness of the backing material 170 preferably varies in the range of from about 0.01 inches to about 0.19 inches, although a range of between about 0.05 inches and 0.12 inches may be most preferred.

As indicated, the polymer application unit 175 applies a deposit of a polymer 178 (FIGS. 3A, 3B) to the backing material 170 after which the height of the polymer is doctored to a desired level.

In the preferred practice, the polymer applied is a polyurethane-forming composition based on a so-called soft segment pre-polymer of MDI (diphenylmethane diisocyanate) or an MDI derivative. The polyurethane-forming composition also preferably incorporates a silicone surfactant to improve both the frothability and stability of the polyurethane layer or “puddle” which is spread across the surface of the backing material 170. For cushion back carpet or tiles, the commonly used foam density is 18 lbs. per cubic foot with a thickness of greater than 0.10 inches. For low weight cushion back carpet or tiles, the preferred density is 16 lbs. per cubic foot with a thickness of 0.06 inches.

One preferred polyurethane-forming composition for use in the present invention is disclosed in U.S. Pat. No. 5,104,693 to Jenkines the teachings of which are incorporated herein by reference. Specifically, the preferred polyurethane-forming composition which is applied across the surface of the carrier backing 170 includes:

A. At least one isocyanate-reactive material having an average equivalent weight of about 1000 to about 5000;

B. An effective amount of blowing agent; and

C. A polyisocyanate in an amount to provide an isocyanate index of between about 90 and about 130, wherein at least 30 percent by weight of such polyisocyanate is a soft segment pre-polymer reaction product of a stoichiometric excess of diphenylmethane diisocyanate (MDI) or a derivative thereof and an isocyanate-reactive organic polymer having an equivalent weight of from about 500 to about 5,000 and wherein the prepolymer has an NCO content of about 10 to about 30 percent by weight.

The polyurethane-forming composition also preferably contains a silicone surfactant to improve frothability and stability in the form of an Organo-silicone polymer such as are disclosed generally in U.S. Pat. No. 4,022,941 to Prokai et al. the teachings of which are incorporated herein by reference. Specifically, the preferred surfactant is preferably a linear siloxane-polyoxyalkylene (AB) block copolymer and specifically a polyalkyleneoxidemethylsiloxane copolymer. One such silicone surfactant which is particularly useful is available under the trade designation L-5614 from OSI Specialties, Inc. whose business address is believed to be 6525 Corners Parkway, Suite 311, Norcross, Ga. 30092.

A sufficient level of the silicone surfactant is used to stabilize the cells of the foaming reaction mixture until curing occurs to allow the preliminary composite 166 to be laid into the uncured polyurethane-forming composition puddle without destabilizing the layer of such polyurethane-forming composition disposed across the surface of the backing material 170. In general, the silicone surfactants are preferably used in amounts ranging from about 0.01 to about 2 parts per hundred parts by weight of component (A) and more preferably from about 0.35 parts to about 1.0 parts by weight of component (A) and most preferably from about 0.4 to 0.75 parts per hundred parts by weight of component (A).

As previously indicated, after disposition of the polymer across the backing material 170 the layer or “puddle” of polymer deposited is preferably doctored to a pre-determined height by means of a doctor blade located at the polymer application unit 175. While a simple mechanical doctor blade is preferred, alternative equivalent means such as an air knife or the like may also be used. Such an air knife is disclosed, for example, in U.S. Pat. No. 4,512,831 to Tillotson (hereby incorporated by reference herein).

In one embodiment, the primary carpet fabric 112 which is preferably joined to reinforcement material 158 to form the preliminary composite 166 is laid directly into the polyurethane-forming composition immediately after it is doctored to the appropriate level without any need to significantly heat either the preliminary composite 166 or the polyurethane-forming composition. Accordingly, the preliminary composite 166 and the backing material 170 with the applied polyurethane-forming composition may be simultaneously delivered at room temperature to a mating roll 180 immediately following the application and doctoring of the polyurethane-forming composition. As will be appreciated, this avoidance of lag time between formation of the components of the cushioned carpet composite permits highly efficient processing readily controllable either manually or by computer control means (not shown) as are well known to those of skill in the art. In the preferred process, the preliminary composite 166 may be slightly preheated to improve operating control during lamination and curing but such preheat is not essential to formation of the desired product.

In the illustrated and preferred embodiment of the carpet, the process described above results in the layer of reinforcement material 158 being laid adjacent to and at least partially embedded in the layer of polyurethane 178. That is, the reinforcement material 158 is preferably in intimate contact with the polyurethane 178 such that the polymer material is bonded to the reinforcement material and will hold the reinforcement in place.

Once the preliminary composite 166 has been laid into the polyurethane-forming composition, the resulting composite may be heated in a heating unit 182 by means of conduction, radiant, or convection heaters as are well known in the art. Contact conduction heaters may be preferred. Such heating may be carried out at a temperature of between about 250° F. and about 325° F. for between about 2 minutes and 8 minutes. The resulting cured foam or foam cushion layer (FIGS. 3A, 3B) which is produced thereby has, for example, a density of between about 12 pounds per cubic foot and about 20 pounds per cubit foot preferably between about 14 pounds per cubic foot and about 16 pounds per cubic foot, and more preferably about 16 pounds per cubic foot.

Following the heat curing operation, the cushioned carpet composite which is formed may be passed over a unidirectional heat source 185 such as a plate heater or roll heater at about 400° F. to fuse any outstanding fibers on the backing material 170 into a sooth surface. The carpet composite, which is formed, will thereafter be rolled, cut, sliced, or the like. When making carpet tiles, it is preferred that it be cut into carpet tiles almost immediately (rather than rolled) to avoid any undesired cupping or curl. After the carpet tiles are cut from the composite, they are stacked, packaged and stored or shipped to the customer or store.

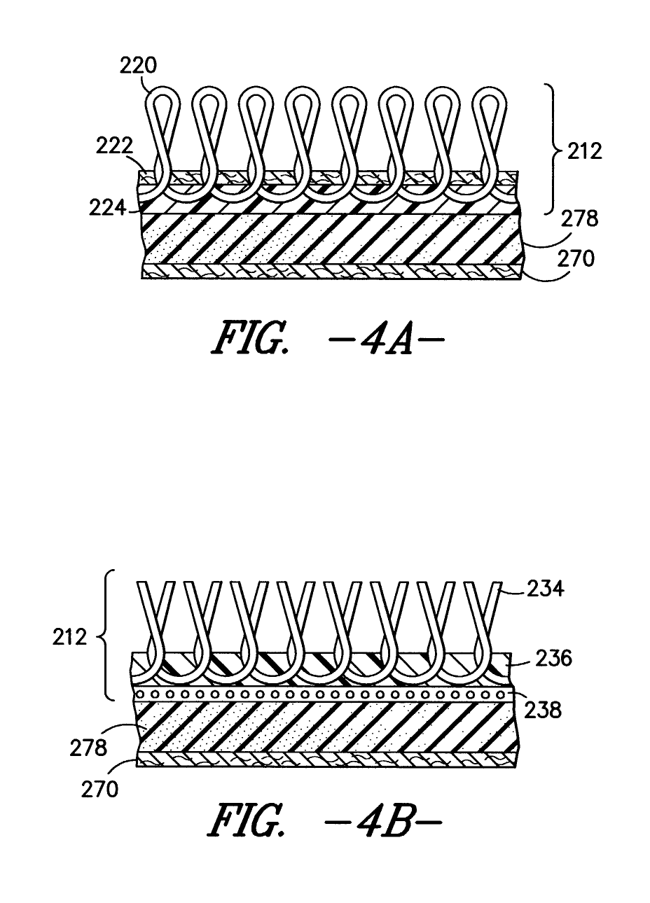

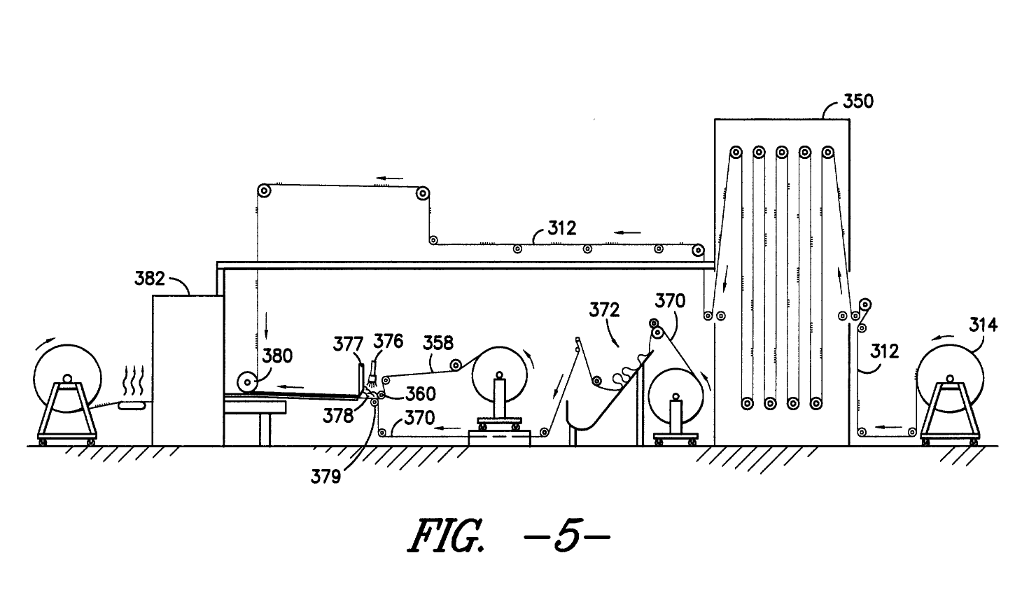

It will be appreciated that a number of alternative practices may be incorporated yielding slightly different products. By way of example only, the reinforcement material 158 may be left completely out of the process thereby making the use of the adhesive application apparatus 155 and adhesive 160 completely unnecessary. In such instances, the primary carpet fabric may be laid directly into the polyurethane-forming composition thereby yielding a composite structure as illustrated in FIGS. 4A and 4B with the polyurethane 278 immediately adjacent to the primary carpet fabric 212 and as described in U.S. Pat. No. 6,203,881 hereby incorporated by reference.

In accordance with another embodiment, when the cushion layer is preformed rather than formed in-situ, a hot melt layer may be used to mate the primary carpet to the cushion layer with or without the reinforcement material. Such a process described in U.S. Pat. No. 4,522,857 hereby incorporated by reference.

In yet another potential alternative, the backing 170, 270 may have an adhesive quick release backing attached to the face to which the polyurethane-forming composition is not applied. As will be appreciated, such a quick release backing will permit the carpet to be readily installed and removed without damaging the polyurethane cushion 178, 278. Moreover, it is contemplated that in some instances the backing 170, 270 might be completely eliminated such that the polyurethane cushion 178, 278 would directly contact the flooring as disclosed in relation to U.S. Pat. No. 4,286,003 which is incorporated herein by reference. Also, an adhesive-free carpet and method is described for example in co-pending U.S. patent application Ser. No. 09/513,020, filed Feb. 25, 2000, and entitled Adhesive-Free Carpet Tiles and Carpet Tile Installations (hereby incorporated by reference herein). It is preferred that carpet tiles for adhesive-free installations have a cup of about 3/16 inch or less and a curl of 1/16 inch or less.

Although it is preferred for the tufted surface covering, tufted modular carpet or modular carpet tile of the present invention to have the following layers: yarn, primary backing, latex pre-coat adhesive, hot melt adhesive, fiberglass, polyurethane, and felt (FIG. 11), it is contemplated that one or more of these layers may be eliminated or substituted for and still provide a carpet or tile having the desired properties or characteristics. For example, the latex pre-coat adhesive layer may be replaced by a bitumen hot melt layer (FIG. 11), the felt layer may be eliminated on a free lay (no floor adhesive) installation product, the glass layer may be eliminated (FIGS. 4A, 4B), or the like.

An alternative process and apparatus for producing a carpet composite is shown schematically in FIG. 5. As illustrated, a primary carpet fabric 312 having either a tufted or a bonded configuration is drawn from a mounted carpet roll 314, through an accumulator 350, in the same manner described above. Simultaneously with the delivery of the primary carpet fabric 312 to the mating roll 380, a reinforcement material 358 such as a non-woven glass is delivered to a polymer contact roll 360 or similar device such as an extrusion coater. The polymer contact roll 360 preferably is in rolling contact with both the surface of the reinforcement material 358 as well as with an accumulation of a polymer 378 such as the polyurethane-forming composition previously described. The polymer contact roll 360 serves to pick up a portion of the polymer 378 and to pass the polymer over and through the reinforcement material 358.

Simultaneously with the passage of polymer through the reinforcement material 358, a backing material 370 such as the non-woven polyester/polypropylene described above is preferably passed in adjacent mating relation to the polymer-coated reinforcement material 358 between the polymer contact roll 360 and a backing material mating roll 379. A doctor blade 377 serves to control the depth of the polymer which does not pass through the reinforcement material 358 into contact with the backing material 370. Thus, it is to be appreciated that a polymer sandwich structure is formed preferably comprising a layer of backing material 370, a relatively thin layer of polymer 378 such as polyurethane which has been passed through a layer of reinforcement material 358, and a doctored layer of polyurethane 378 which was not passed through the reinforcement material 358. This polymer sandwich structure can thereafter be passed to the mating roll 380 for joinder with the primary carpet fabric 312 by laying the primary carpet fabric 312 directly into the doctored layer of polyurethane 378 without any pre-curing operation. Thereafter, the composite is heated, cured, and rolled or cut.

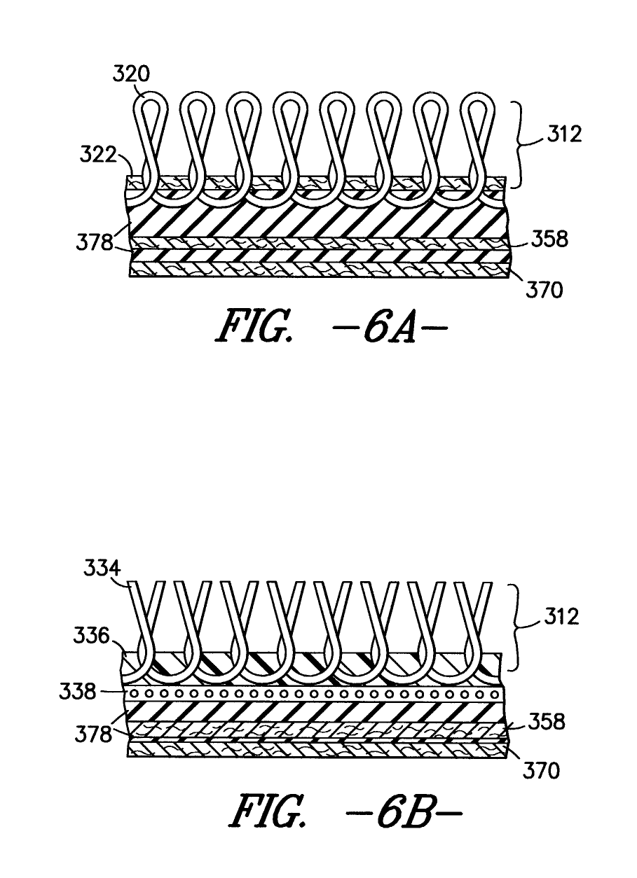

A potentially preferred configuration for a resulting tufted carpet composite is illustrated in FIG. 6A. As illustrated, the reinforcement material 358 will be at least partially surrounded by, and embedded in, the polyurethane 378. As illustrated, it is contemplated that the layer of pre-coat may be eliminated in the tufted structure since the tufts may be held in place by the polyurethane 378. A potentially preferred configuration for a resulting bonded carpet composite is shown in FIG. 6B.

With respect to FIG. 5A of the drawings, the reinforcement material and hot melt layers can be eliminated simply by not feeding the reinforcement 358 along with the felt 370 and primary carpet 312.

A further alternative process and apparatus for joining all layers of the carpet composite is illustrated in FIG. 7. As shown, a layer of reinforcement material 358 is preferably passed adjacent to a polymer contact roll 360 which is in simultaneous rolling contact with both the reinforcement material 358 and a deposit of polymer 378. The polymer contact roll 360 serves to spread a portion of the polymer 378 through the reinforcement material 358 to create a coating on both sides thereof. The reinforcement material 358 with its coating of polymer 378 is then joined in a laminate structure to the primary carpet fabric 312 and a layer of backing material 370 by passage through the nip between the doctor blade 377 and backing material mating roll 379. Thereafter, the composite is heated, cured, and rolled or cut. This practice will yield a bonded carpet composite structure substantially similar to those which are illustrated in FIGS. 6A and 6B.

In accordance with one aspect of the present invention, the designs that are tufted, woven, printed, or dyed on the modular carpet or carpet tile are preferably characterized as orientation independent or as having the ability to seam properly without cutting the tiles in register with the design. The techniques used to create these designs make it possible to install modular carpet monolithically rather than quarter turn or ashler. The commonly used techniques of modular carpet installation such as quarter turn (parquet), monolithic, and ashler (brick) may be used to install carpet or carpet tiles of the present invention. The preferred technique is monolithic or ashler. Also, a floor adhesive may or may not be used depending on whether the carpet or tile is designed for adhesive-free installation or adhesive installation. Also, the carpet tile may be self-stick and contain an adhesive quick release backing attached to the face of the backing 170, 270 opposite the polyurethane.

The carpet tile of the present invention is very durable and preferably can withstand 25,000 cycles or more of the caster chair test without failure.

There are at least four options or examples of the foam cushion to obtain commercially acceptable foam products using polyurethane.

1) Use of standard filled Polyurethane system. One polyurethane foam contains 110 parts of filler and is applied as low a density as 15 #/cu. ft. If the thickness is in the range of 0.04-0.12 and we determine polymer weight only, using the density and filler levels above, the weight range of the polymer would be 4.32 oz/sq yd to 12.96 oz/sq yd.

2) A second option which would also work would be to increase the filler levels to 190 and reduce the density to 13 #/cu. ft. (Min. which is possible with a filled system). At the same thickness limits the polymer weights would then be 2.72-8.24 oz/sq. yd.

3) A third option would be to use an unfilled polyurethane (Prime urethane) system. High densities such as above are not possible with prime however, they perform because of the wall structure and the fact that no filler is present if we consider a prime to be at 6 #/cu. ft. applied at the thickness limits above the polymer weight would be 2.88-8.64 oz/sq. yd.

4) A fourth option is also possible. Textile Rubber has a polyurethane system available called “Kangahide” which has only 15 parts of a filler material and is applied at 6-9 lb/cu. ft. density, if a polymer calculation is again made at the describe thickness limits it would be 4.3-13.02 oz/sq. yd.

Although the above examples have to do with Polyurethane, a water based foam system can also be used.

Although it is preferred to print the carpet composite and then cut tiles therefrom, the carpet composite may be cut into tiles and then each cut tile may be printed or dyed. For example, the cut tiles or blanks may be jet dyed or dye injection printed. This provides for improved design or pattern registration on the tiles and allows for monolithic installation of complex designs.

In accordance with at least one embodiment of the present invention, a hardback or hardback like carpet tile is created using a thin layer of adhesive, such as polyurethane foam as the lamination layer between the carpet composite and a backing material such as a non-woven polyester or non-woven polyester/polypropylene blended layer. The carpet composite preferably consists of a reinforcement material, such as a fiberglass mat, a layer of adhesive or tie-coat such as hot melt and a primary carpet fabric including latex, and carpet. The thickness of the adhesive polyurethane foam layer is preferably less than about 0.090 inch. The polyurethane add-on is preferably less than about 15 ounces per square yard. The cup-weight of the polyurethane is 380 g/l+/−20 g/l. The polyurethane is preferably applied to the non-woven with a blade over roll coater. The gap distance between the blade and roll is less than 0.100 inch.

Alternatively, a hot melt may also be used as the lamination layer (rather than polyurethane foam). The hot melt is applied at a temperature of above 300 degrees F. The hot melt add-on is 20+/−10 ounces per square yard. The thickness of the hot melt lamination layer between the carpet composite and the non-woven is less than 0.090 inch. The density of the hot melt is 18 lbs./gallon +/−5 lbs./gallon.

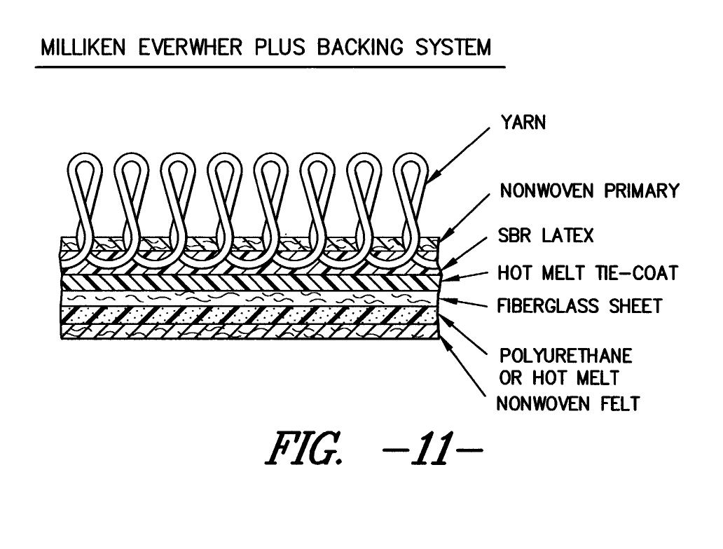

One purpose of the present invention is to create a hardback or hardback like tile with a non-woven backing using polyurethane or hot melt as the lamination layer. The hardback or hardback like product of the present invention (FIG. 11) replaces current hardback product (FIG. 10), which does not have a non-woven backing. Current hardback product consists of a latex pre-coat backing applied to the tufts of a primary carpet fabric and two layers of hot melt separated by a glass layer. The first hot melt layer (50+/−10 ounces per square yard) laminates the fiberglass mat to the carpet and latex layer. The second hot melt layer (60+-10 ounces per square yard) serves as the hardback layer. This layer adds stability and moisture barrier.

The present invention allows the use of current technology on carpet tile coating ranges to create a hardback or hardback like product that runs at least 1.5 times the productivity as the old hardback process. The new process runs over 40 feet per minute line speed; whereas, the old process runs at less than 25 feet per minute.

One advantage of this invention is that one can process polyurethane cushion backed products and also utilize the same equipment to make a hardback or hardback like product. This hardback product also has an advantage over conventional hardback products because it has a releasable, non-woven backing. It also may have better underfoot comfort than normal hardback products because of the thin layer of polyurethane (and the non-woven).

Adding a non-woven, such as a felt to the back of a hardback tile adds desirable vapor and moisture transport characteristics enjoyed by felt backed cushion back products. The non-woven backing allows moisture to wick to the edges or seams and to escape. Also, the non-woven backing serves as a release layer that can be used with many types of adhesives to allow the tile to be glued down to a floor and later removed without leaving a portion of the foam layer on the floor. It is preferred to either use no adhesive between the tile and floor (adhesive free installation) or to use a low VOC releasable adhesive which provides some lateral grip and a little vertical grip.

Still further, the non-woven backing may have a polypropylene content that can be adjusted, for example, between 30 and 40% by weight, to adjust the cup in the tile.

It is preferred to have a flat tile or a tile with a little cup. As the polypropylene in the non-woven backing shrinks, it creates a force which counters any shrink in the carpet or primary backing and may create a slight cup.

The glass layer is very dimensionally stable with respect to shrink, growth or skew.

Hence, the final carpet tile product is very dimensionally stable (substantially no shrink, growth, or skew), has little or no cup, and has no curl (corners do not curl up).

In accordance with the present invention, it has been unexpectedly discovered that a hardback like product may be formed on the same range used for making cushion back carpet tiles by, for example, reducing the density of the polyurethane (increasing the amount of air added by mechanically frothing at a higher speed) and reducing the add-on of polyurethane to a thin coating useful as an adhesive between the glass and felt.

Also, it has been discovered that the same range or production line can be used to make three different products, by for example, changing the primary carpet fabric, changing the add-on of polyurethane, and changing the density of the polyurethane. Hence, the same range or equipment may be used to form cushion back carpet tile (dense, thick foam cushion), low weight cushion back carpet tile (less dense, thinner foam cushion), and hardback like carpet tile (much less dense, much thinner polyurethane coating).

In accordance with the present invention, the following are exemplary examples of a hardback like carpet composite or tile (FIG. 11).

### EXAMPLE I

EVERWHER ™ Plus With Polyurethane Specification*

| | Preferred Embodiment |
|---|---|
| 1. | Product Name: First Appearances (Obex) |
| 2. | Face: Cut Pile |
| 3. | Primary Backing: Woven Colback (4 oz/sq yd) |
| 4. | Total Finished Yarn Weight: 26 oz/sq yd |
| 5. | Stitches Per Inch: 5.59 |
| 6. | Tufting Gauge: 5/32 |
| 7. | Yarn Polymer: Nylon |
| 8. | Yarn Type: Nylon |
| 9. | Yarn Twist: 4 by 4; S by “Z” |
| 10. | Yarn Ply: 2 |
| 11. | Heatset: Yes |
| 12. | Yarn Size: 1.57/2 |
| 13. | Dyeing Method: Jet Dye, Millitron jet dye machine |
| 14. | Precoat adhesive: Styrene Butadiene Latex, 12 oz/sq yd |
| | coating weight |
| 15. | Lamination Tiecoat Adhesive: Hot melt with a bitumen and |
| | polypropylene resin base at 46 oz/sq yd |
| 16. | Stabilizing Reinforcement: Fiberglass mat, 2 oz/sq yd, |
| | modified acrylic binder |
| 17. | Lower Tiecoat Weight: Polyurethane with 380 g/l density at |
| | 12 +\−3 oz/sq yd |
| 18. | Polyurethane Thickness: Less than 0.090 inch |
| 19. | Release layer construction: Nonwoven felt |
| 20. | Release layer composition: 70% polyester/30% polypropylene blend |
| 21. | Release layer weight: 4 oz/sq yd |
| 22. | Modular shape and size: 18″ by 18″ or 36″ by 36″ |
| 23. | Cutting method: Die cut face up. |

*This product has the same carpet face as the EVERWHER ™ hardback tile described above so as to provide a comparison of EVERWHER ™ AND EVERWHERE PLUS ™ products.

### EXAMPLE II

EVERWHER ™ Plus With Hot Melt Specification

| | Preferred Embodiment |
|---|---|
| 1. | Product Name: First Appearances (Obex) |
| 2. | Face: Cut Pile |
| 3. | Primary Backing: Woven Colback (4 oz/sq yd) |
| 4. | Total Finished Yarn Weight: 26 oz/sq yd |
| 5. | Stitches Per Inch: 5.59 |
| 6. | Tufting Gauge: 5/32 |
| 7. | Yarn Polymer: Nylon |
| 8. | Yarn Type: Nylon |
| 9. | Yarn Twist: 4 by 4; 5 by “Z” |
| 10. | Yarn Ply: 2 |
| 11. | Heatset: Yes |
| 12. | Yarn Size: 1.57/2 |
| 13. | Dyeing Method: Jet Dye, Millitron jet dye machine |
| 14. | Precoat adhesive: Styrene Butadiene Latex, 12 oz/sq yd |
| | coating weight |
| 15. | Lamination Tiecoat Adhesive: Hot melt with a bitumen and |
| | polypropylene resin base at 46 oz/sq yd |
| 16. | Stabilizing Reinforcement: Fiberglass mat, 2 oz/sq yd, modified |
| | acrylic binder |
| 17. | Lower Tiecoat Weight: Hot melt with a bitumen and polyproylene |
| | resin base at 25+\−10 oz/sq yd. |
| 18. | Release layer construction: Nonwoven felt |
| 19. | Release layer composition: 70% polyester/30% polypropylene blend |
| 20. | Release layer weight: 4 oz/sq yd |
| 21. | Modular shape and size: 18″ by 18″ or 36″ by 36″ |
| 22. | Cuffing method: Die cut face up. |

TEST RESULTS OF
COMPARISON OF EVERWHER ™ PLUS (polyurethane tile)
VS. STANDARD EVERWHER ™ (hardback tile)

| | EVERWHER ™ + | EVERWHER ™ | PASSING |
|---|---|---|---|
| TEST | (polyurethane) | (hardback) | REQUIREMENT |
| Radiant Panel | 1.10 | 0.94 | >/=0.45 |
| Electrostatic | 3.0 | 2.25 | </=3.50 |
| Propensity | | | |
| NBS Smoke | 371 | 222 | <450 |
| (Flaming-DM, | | | |
| corrected) | | | |
| Flexibility | Flexible | Flexible | Some flexibility preferred. |
| Aachen | Pass | Pass | <0.02 |
| Pill Test | Pass | Pass | No substantial pilling. |
| Phillips Chair | 3.0 | Pass | 3.0 or better |
| (caster chair) | | | |
| Compression | 89% | 88% | About 90% or more. |
| and Recovery | | | |
| Ball Bounce | 22 | 12 | Comfort Plus cushion back tile is |
| | | | >25 |
| Gmax | 210 | 260 | Comfort Plus cushion back tile is |
| | | | about 80 to 120. (30 points on |
| | | | this scale is significant) |

Comfort Rating

1. Gmax—Gmax simulates footfall onto a surface. The measure is reported as multiples of “g” (gravities), or Gmax. The lower the value, the lower the force upon impact, and the more comfortable underfoot the product feels. The higher the value, the higher the force upon impact, and the less comfortable the carpet feels.

Gmax Test Results

Standard Milliken ComfortPlus® cushion-backed carpet tile—116

EVERWHER PLUS™ (polyurethane lamination) hardback like carpet tile of the present invention (same face as standard Milliken EVERWHER® carpet tile below)—210

Standard commercial broadloom without underlayment—185

Standard hardback carpet tile, such as Milliken EVERWHER™ hardback—260

Resilience Rating/Ball Bounce

Cushion Resilience—Cushion resiliency measures the rebound percent of a metal ball when dropped from a standard height. It shows the shock absorbing character of the cushion, which helps reduce visible wear of the carpet face. The higher the value, the higher the rebound percent, and the more resilient the cushion.

Resilience Results

Standard Milliken ComfortPlus® cushion backed carpet tile—30

EVERWHER PLUS™ polyurethane carpet tile of the present invention (same face as standard Milliken EVERWHERTM carpet file below)—22

Standard commercial broadloom without underlayment—17

Standard hardback Milliken EVERWHERTM carpet tile—12

Appearance Retention

Appearance Retention Rating (ARR)—the ARR value is determined by grading the appearance change of carpet subjected to exposure conditions in accordance with either the ASTM D-5252 (Hexapod) or ASTM D-5417 (Vettermann) test method using the number of cycles for short and long-term tests specified.

ARR—Light (short-term>/#3.0, long-term>/=2.5

ARR—Moderate (short-term>/#3.5, long-term >/=3.0

ARR—Heavy (short-term>/=4.0, long-term >/=3.5

The hardback or hardback like modular carpet tile of the present invention preferably has an APR of about 4 or better short term and 3 or better long term.

Durability

The hardback or hardback like carpet tile of the present invention is preferably very durable and can withstand 25,000 cycles or more of the caster chair test without failure.

EN 1307: Classification of Pile Carpets

This standard sorts carpets into four categories, depending on their ability to withstand differing degrees of wear.

The categories are:

Class 1 Light intensity of use (domestic only).

Class 2 General (domestic or very light contract).

Class 3 Heavy, e.g. use in general contract areas.

Class 4 Very Heavy, e.g. use in Extreme contract areas.

Three test methods are combined to provide the classification,

1. Fuzzing or loss of mass, on the step—scuff test EN 1963.

2. I (tr) according to EN 1963. The carpet is shorn down to the backing, and various parameters such as Surface Pile weight and height, Surface pile density are measured.

I (tr) is a numerical value calculated according to a mathematical formula which includes the above test measurements.

The required value of I (tr) is higher the higher the classification.

3. Hexapod or Vettermann drum test for change in surface appearance, ISO/TR 10361.

Again, the higher the class, the higher the requirement.

In addition, there are requirements for either minimum Surface Pile weight, or Surface Pile density for contract-grade carpets.

This system is used for carpets with low, dense pile. There is a different system for carpets with high pile.

It is preferred to have a carpet composite or tile with a castor chair rating of >2.3 (test and evaluation method EN 54324). A 2.4 or higher is a contract rating.

It is preferred to have a carpet composite or tile with EN 1307 rating of >2.

It is preferred to have a carpet composite or tile with Herzog walking comfort rating for contract use (DIN 54327) of >0.7.

It is, of course, to be appreciated that while several potentially preferred embodiments have been shown and described, the invention is in no way to be limited thereto, since modifications may be made and other embodiments of the principles of this invention will occur to those skilled in the art to which this invention pertains. Therefore, it is contemplated by the appended claims to cover any such modifications and other embodiments as incorporate the features of this invention within the true spirit and scope thereof.

1. A surface covering, wall covering, flooring, carpet, roll product, or carpet tile as shown or described herein, comprising a carpet layer, an adhesive layer, and a non-woven backing.

2. The surface covering, wall covering, flooring, carpet, roll product, or carpet tile as recited in claim 1, wherein said adhesive layer is a polyurethane layer less than about 0.09 inch thick.

3. The surface covering, wall covering, flooring, carpet, roll product, or carpet tile as recited in claim 1, further comprising a tie-coat adhesive layer between the carpet layer and a reinforcement material.

4. The surface covering, wall covering, flooring, carpet, roll product, or carpet tile as recited in claim 3, wherein said reinforcement material is a fiberglass mat.

5. The surface covering, wall covering, flooring, carpet, roll product, or carpet tile as recited in claim 1, exhibiting performance characteristics that rate it for heavy commercial use.

6. The surface covering, wall covering, flooring, carpet, roll product, or carpet tile as recited in claim 1, wherein said adhesive layer is a hot melt adhesive.

7. The surface covering, wall covering, flooring, carpet, roll product, or carpet tile as recited in claim 1, wherein the carpet is at least one of tufted and bonded.

8. The surface covering, wall covering, flooring, carpet, roll product, or carpet tile as recited in claim 1, wherein the non-woven backing is at least one of polyester and polypropylene.

9. A carpet tile, comprising a primary carpet, a thin polyurethane layer, and a non-woven cushion backing.

10. The carpet tile as recited in claim 9, exhibiting performance characteristics that rate it for a heavy commercial use.

11. The carpet tile as recited in claim 9, wherein said polyurethane layer is less than about 0.09 inches thick.

12. The carpet tile as recited in claim 9, wherein the carpet is at least one of tufted and bonded.

13. The carpet tile as recited in claim 9, wherein the carpet is printed or dyed.

14. A carpet tile, comprising a layered structure of a primary carpet precursor, latex pre-coat adhesive, hot melt adhesive, fiberglass, polyurethane adhesive and felt.

15. A modular carpet tile comprising a layered structure of a primary carpet, bitumen hot melt layer, fiberglass, polyurethane adhesive, and felt.

16. A method of forming a modular carpet tile comprising the steps of:
adhesively bonding a layer of glass reinforcement material to the base of a primary carpet fabric to form a laminate composite,
placing a layer of mechanically frothed, wet polyurethane forming composition into direct contact relation with a layer of non-woven backing material to form a polyurethane layer of less than about 0.09 inches thick, and
joining the polyurethane layer to the glass reinforcement material to form a modular carpet composite, and cutting carpet tiles from the carpet composite.

17. A carpet tile produced by the method of claim 16.

18. A method of marketing carpet to carpet customers, comprising the steps of offering to the customer at least one of each of standard cushion back carpet tile, low weight cushion back carpet tile and hardback carpet tile to satisfy all of their carpet needs and thereby replace broadloom carpet.

19. A method of producing hardback like carpet tiles using a cushion back carpet tile range, comprising the steps of:
reducing the density of the polyurethane,
and reducing the add-on of polyurethane.

20. A method of selectively producing one of three different carpet tile products using a polyurethane range, comprising the steps of:
changing the carpet, adjusting the density of polyurethene, and adjusting the add-on of polyurethane.

21. The carpet tile as recited in claim 9, having a ball bounce rating of at least 15 and a Gmax rating of less than 250.

22. The carpet tile as recited in claim 9, having a ball bounce rating of at least 20 and a Gmax rating of less than 220.

23. The carpet tile as recited in claim 14, having a ball bounce rating of at least 15 and a Gmax rating of less than 250.

24. The carpet tile as recited in claim 14, having a ball bounce rating of at least 20 and a Gmax rating of less than 220.

25. The carpet tile as recited in claim 15, having a ball bounce rating of at least 15 and a Gmax rating of less than 250.

26. The carpet tile as recited in claim 15, having a ball bounce rating of at least 20 and a Gmax rating of less than 220.
